(19) United States
(12) Patent Application Publication
(10) Pub. No.: US 2009/0265197 A1
(43) Pub. Date: Oct. 22, 2009

(54) SYSTEM AND METHOD FOR BUILDING SHARED ITINERARIES

(75) Inventor: Kai Cheung Chan, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: KIDULT INC LIMITED, Hong Kong (CN)

(21) Appl. No.: 12/104,739

(22) Filed: Apr. 17, 2008

(51) Int. Cl. G06F 17/30; G06Q 10/00

(52) U.S. Cl. 705/7; 705/1

(57) ABSTRACT

A method implemented by a computer allows a user to create an electronic itinerary, parts of which may later be purchased through an electronic reservation system and, at the same time, to find a suitable traveling companion. The method provides compatibility between user itineraries to be determined based upon a classification of activities making up the itineraries. The user may select from compatible itineraries an itinerary and associated subscriber to companion him on a trip. A method is provided for communicating between the user and a selected subscriber to negotiate a shared itinerary.

### TECHNICAL FIELD

The present invention relates to computer-aided itinerary builders and to computer-aided social interactions, and in particular to online systems and methods for allowing users to build shared itineraries for planning travel.

### BACKGROUND OF THE INVENTION

Travel, and particularly leisure travel, provides an opportunity to see and do interesting things and the enjoyment of these things is enhanced by the opportunity to share the experience with others, whether local people from the destination area or fellow travellers from elsewhere. The shared experience can provide fond memories of a visit, and stories to tell upon return home. If the travellers in a group have identical mutual interests they can consult the same maps, timetables and guides, providing companionship and helping one another on.

A large number of single individuals in particular now have the resources and desire to travel yet choose not to, because they are unable to find companions to travel with and they find doing some activities alone to be intimidating. Recent years have seen increasing use of the internet for providing social interactions between people who may be in widely separate locations. So-called electronic “bulletin boards” provide a resource for these travellers seeking others to share a trip. When seeking a travel companion a user may post to such a bulletin-board an itinerary of the trip and some personal detail. However, there are a number of drawbacks in this method. The user must first investigate the many different sources of information available on the internet of different attractions to prepare the itinerary, before preparing it in written form and returning to the bulletin-board. Searching through a large number of postings is time-consuming. It may be difficult for two potential companions to assess the compatibility of both their schedules and other preferences, without initiating an extended conversation, despite a shared interest in specific attractions.

With the advent of electronic commerce, tourism products have become one of the most traded items on the internet. Although the evolution of tourism in the last few years has been irregular, industry forecasters expect continued growth in this sector in the future. Providers such as hotels, airlines and rental car companies sell their services directly, and these same services are also widely available through intermediaries who are able to package them to meet the requirements of various travelers. This situation has lead to increasingly sophisticated services being required, and increasing demands upon these intermediaries, such as online travel agents and travel planning websites. Travel planning websites have enabled individual users to select from packaged itineraries, for instance comprising train tickets and hotel reservations. Furthermore, to assist in providing a fuller itinerary, these websites may include information about tourist attractions and allow the user to build an itinerary allocating time to visit different attractions or to complete activities of particular interest. However, there is a need to further improve the electronic services to travellers and particularly for a system and method providing activities to users from many sources and allowing users to build and book travel itineraries while allowing these itineraries to be shared with compatible travellers.

### DISCLOSURE OF THE INVENTION

According to one aspect of the present invention there is provided a method implemented by a computer for generating an itinerary to be shared by a user and a first subscriber from a group of subscribers, the method comprising:
a) generating a plurality of subscriber itineraries each associated with a subscriber, each subscriber itinerary including one or more activities selected from a user activity pool, each activity including activity data, the activity data including an activity location associated with performing the activity;
b) generating a user itinerary for a user, the user itinerary including one or more activities selected from the user activity pool;
c) identifying compatible itineraries from among the subscriber itineraries, compatible subscriber itineraries including at least one activity having an activity location in common with an activity location of an activity in the user itinerary,
d) displaying a selection from the compatible itineraries;
e) receiving a selection from among the displayed itineraries of a first subscriber itinerary associated with the first subscriber;
f) receiving a user selection indicating a desire to contact the first subscriber with a request that the first subscriber accompany the user on either the user itinerary or on the first subscriber itinerary, and
g) initiating contact with the first subscriber in response to the user selection.

Preferably, if more than one compatible subscriber itinerary is identified at step c) the method further includes calculating a rating for each compatible subscriber itinerary which increases with the number of activities having activity locations shared with the user itinerary, and at step d) displaying a selection from the compatible itineraries with the highest ratings.

Preferably step g) includes transmitting an email specifying the request that the first subscriber accompany the user on either the user itinerary or on the first subscriber itinerary according to the user selection.

Preferably the activities are classified according to at least one classification included in the activity data and wherein the rating calculated at step (d) is further increased according to the number of activities having both activity locations and classifications shared with the user itinerary.

Preferably calculating the rating further includes the step of incorporating in the rating a scoring based upon analysis of the results of a questionnaire completed by the user and subscribers. For instance, prior to performing the method, the user and subscribers may each complete a questionnaire requiring them to indicate a level of interest in certain topics, the scoring increasing with common interest in the topics. In this way the probable compatibility between the user and first subscriber is increased.

Preferably generating a user or subscriber itinerary at step a) or step b) includes:

receiving a user selection of the user activity pool;

displaying a list of activities of the user activity pool;

displaying an itinerary template, and

receiving into timeslots in the itinerary template selected ones of the displayed user activity pool to complete the itinerary.

Optionally receiving the user selection of the user activity pool may comprise either:

receiving a user selection of a pre-defined itinerary or a pre-defined itinerary part defining the user activity pool, or

receiving a user selection of individual activities from a starting set of activities to define the activities of the user activity pool.

Preferably the generation of each subscriber itinerary at step a) further includes:

receiving input into fields in a subscriber registration file, the fields including a subscriber name field, a subscriber email address field

saving each subscriber registration file with an associated subscriber itinerary.

Preferably the selected ones of the activities are placed into the timeslots by a drag-and-drop selection from the displayed user activity pool.

The activities preferably include date-specific activities which can be performed within a date window and the method includes:

receiving a selection, separate from the selection of an activity, of a proposed date range during which it is proposed to complete the itinerary,

identifying a date window in the activity data for each date-specific activity and checking for conflict between the date window and the proposed date range and highlighting any activities found to conflict.

Preferably the activities include purchasable and non-purchasable activities, and the method further includes: sending the itinerary to an electronic reservation system such that the electronic reservation system creates a reservation record, the reservation record comprising a reservation for each purchasable activity.

Preferably displaying the itinerary includes displaying either expanded or compressed views of a itinerary conditionally upon the state of a display toggle control, the expanded view including a plurality of graphical user interface boxes of like size and spaced apart in a rectangular matrix, each of the graphical user interface boxes holding activity data, with indicia along a common edge of each graphical user interface box defining a time associated with a timeslot in the itinerary and a title associated with each activity, and the compressed view resembling a stack of the graphical user interface boxes with the indicia positioned adjacent one another in sequential order according to the displayed time such that only activity data in a front graphical user interface box is visible.

Preferably the common edge is an upper edge of each graphical user interface box and the rectangular matrix comprises two adjacent columns, such that graphical user interface boxes for consecutive activities are in transversely opposing ones of the columns and are staggered vertically.

Preferably displaying the itinerary includes displaying the proposed date range in both the compressed and expanded views.

Preferably the method further comprises: moving a selected activity from one day timeslot to a different timeslot in response to a drag-and-drop selection and placement by the user.

In another aspect the invention provides a display arrangement system for displaying an itinerary in which each timeslot in the itinerary is represented as a graphical user interface box on a graphical user interface, the display arrangement system comprising:

(a) a display for displaying the set of graphical user interface boxes in the graphical user interface;

(b) a memory for storing a plurality of instructions that are associated with a plurality of functions; and

(c) a processor for executing the plurality of instructions stored in the memory upon a change of state of a display toggle control, the execution of the plurality of instructions causing at least one of the plurality of functions to be performed, including:
(i) generating an expanded view of a plurality of the graphical user interface boxes, the graphical user interface boxes having a like size and being spaced apart in a rectangular matrix, each of the graphical user interface boxes holding activity data and defining a timeslot in the itinerary, with indicia along a common edge of each graphical user interface box defining a time associated with the timeslot and a title associated with each activity, and
(ii) generating a compressed view of a plurality of the graphical user interface boxes, the compressed view resembling a stack of the graphical user interface boxes with the indicia positioned adjacent one another in sequential order according to the displayed time such that only activity data in a front graphical user interface box is visible.

A computer-readable medium having executable instructions for performing functions for generating an itinerary to be shared by a user and a first subscriber from a group of subscribers, the instructions comprising:
a) generating a plurality of subscriber itineraries each associated with a subscriber, each subscriber itinerary including one or more activities selected from a user activity pool, each activity including activity data, the activity data including an activity location associated with performing the activity;
b) generating a user itinerary for a user, the user itinerary including one or more activities selected from the user activity pool;
c) identifying compatible itineraries from among the subscriber itineraries, compatible subscriber itineraries including at least one activity having an activity location in common with an activity location of an activity in the user itinerary,
d) displaying a selection from the compatible itineraries;
e) receiving a selection from among the displayed itineraries of a first subscriber itinerary associated with the first subscriber;
f) receiving a user selection indicating a desire to contact the first subscriber with a request that the first subscriber accompany the user on either the user itinerary or on the first subscriber itinerary, and
g) initiating contact with the first subscriber in response to the user selection.

### BRIEF DESCRIPTION OF THE DRAWINGS

Preferred forms of the present invention will now be described by way of example with reference to the accompanying drawings, wherein:

FIG. 1 is a schematic illustration of a preferred system for performing the method of the invention;

FIG. 2 is a flow chart illustrating major steps in the method of the invention;

FIG. 3 is a flow chart illustrating the selection of activities in the method of FIG. 2;

FIG. 4 is a flow chart illustrating the generation of an itinerary in the method of FIG. 2;

FIG. 5 is a screen shot of a graphical user interface showing a single box/activity in the itinerary editor;

FIG. 6 is a screen shot of a compressed view of a one-day itinerary showing a plurality of “stacked” boxes each displaying an activity;

FIG. 7 is a screen shot of the itinerary of FIG. 6 in an expanded view;

FIG. 8 is a flow chart illustrating the determination of compatible itineraries in the method of FIG. 2; and

FIG. 9 is a flow chart illustrating the generation of a shared itinerary in the method of FIG. 2.

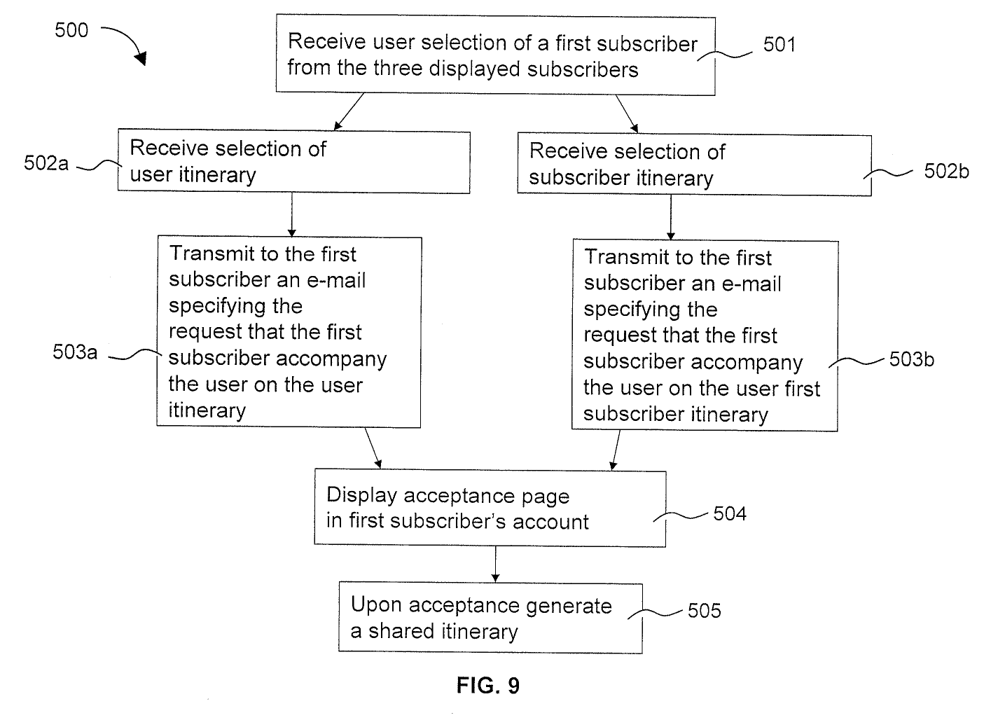

### DESCRIPTION OF THE PREFERRED EMBODIMENTS

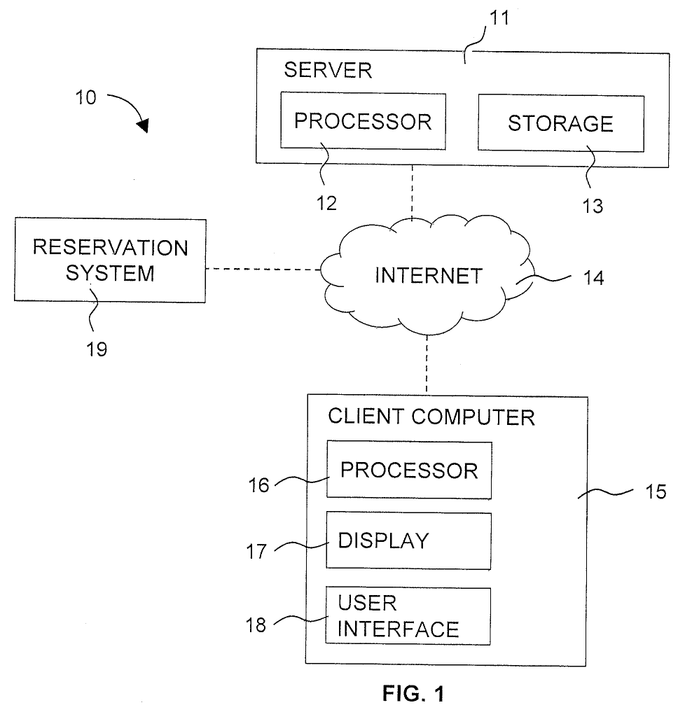

Referring firstly to FIG. 1, the illustrated system is intended for use according to the invention to match a subscriber and user who may wish to complete a trip together, and particularly for matching a subscriber and user who have a degree of compatibility, with similar interests or needs so that they can have a more enjoyable trip. The subscriber and user may be an individual or a group of individuals such as a couple, or a family, undertaking to generate itineraries according to the present invention, for planning and completing travel activities with others.

The itinerary comprises activities that generally include travel activities involving travel between locations and activities based at certain locations including, but not limited to, visits to attractions. Although the method may be used to create itineraries excluding purchasable activities, the activities may require reservations and payment.

The system 10 includes a server 11 operatively coupled to the internet 14 and a plurality of user computers 15 operatively coupled to the internet. The server 10 comprises a processor 12 and storage 13. The client computer comprises a processor 16, a display element 17 such as an LCD display , and a user interface 18 such as a keyboard and mouse.

Server 10 may communicate over the internet with many different sources to obtain activities. Held in the storage 13 is a database including a starting set of activities and pre-defined itineraries built up of scheduled activities. The database is built using the processor 12 of the server to analyse obtained activities. Each of the activities in the starting set and the pre-defined itineraries are broadly categorised under categories such as transport, accommodation, or attraction. Sub-categories within the transport category may include airline, bus, and train.

Activities are also typically coded to indicate a correspondence between the activity and one or more defined geographic locations and at least one time window. A time window may include, for example, the weeks in spring in which cherry blossom can be seen, the day of an annual festival or the scheduled times for flights. A location is associated with the activity, for instance where it takes place, starts or ends. Different activities may share the same location, for instance the location may be a building housing different restaurants. Activities may be categorised according to cost, for example, luxury, mid-range, budget or special character classes. Activities are also categorized by the type of trip or experience. For example, an activity may be related to food, drink, excitement, culture, entertainment, places of interest, shopping. Activities may also be categorized by the typical traveller to whom it might appeal. Such a categorization may include demographic information such as income, age, gender, marital status, interests, hobbies, etc. Information may also be categorized by the other travel locations or activities to which the itinerary or activity might relate (i.e., other destinations or activities that a person travelling to this location might like to do and that is in the general proximity).

To plan and book a trip, the user may enter a request via the client computer 15 using user interface 18. The processor 16 transmits the request to the server 11 over network 14. In response to the user request, the processor 12 of server 10 may access activity and itinerary information corresponding to and satisfying the user request from the storage 13. The information is then typically transmitted by the server 10 to the client computer 15, and displayed for the user on the display 20, allowing an itinerary to be built.

An itinerary may be saved in the database and the user may elect to have the itinerary flagged as accessible to other users, providing an invitation to others to accompany the user on the itinerary. When a new itinerary is created by a user, flagged itineraries are rated by the processor 12 for compatibility with the new itinerary, the user is then able to select from compatible itineraries and initiate communication with a compatible subscriber with a view to completing an itinerary together.

To make any payments and reservations required, such as via user interface 22, the user may select a complete itinerary or some portion of the itinerary, and the processor 12 of server 10 will typically determine the price and availability of each activity. Price and availability information will typically be obtained from a reservation system 19, such as the reservation system for an airline, car rental agency, or hotel and transmitted from the server to the client device to be displayed for the user. Alternatively this price and availability information may be obtained from an intermediary, such as a travel agent (not shown). When the user is satisfied with the user itinerary, the processor 12 will then typically book the purchasable activities by transmitting information to a reservation system 19. After the user itinerary is completed, the processor 12 will typically store the user itinerary in the storage element 14 for use as activities for a future user request.

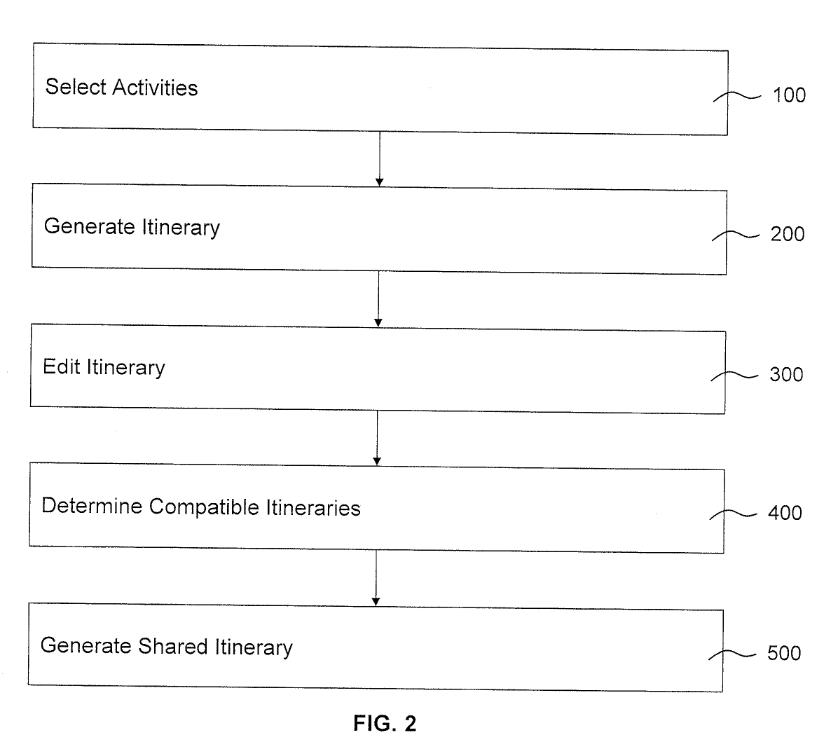

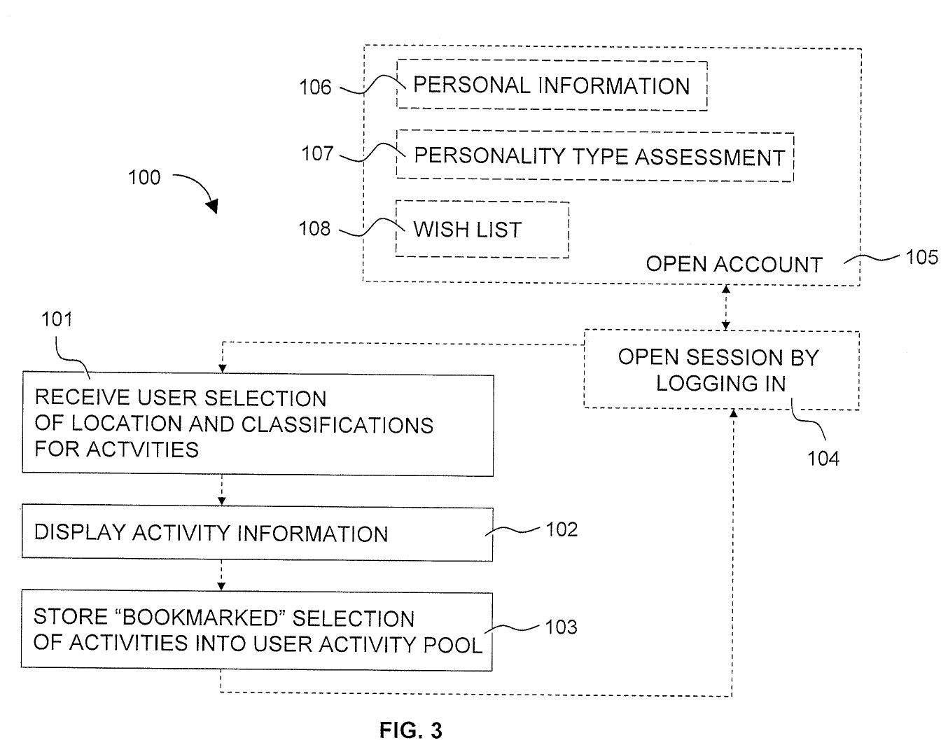

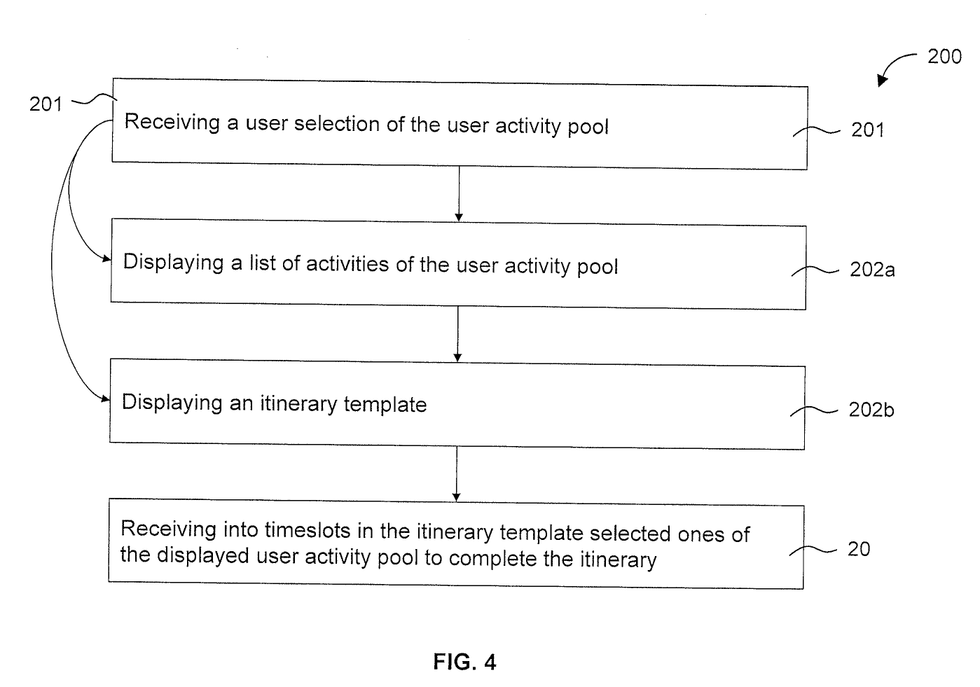

Reference is now made to FIG. 2, which is an outline of a process of arranging a shared itinerary among a user and a subscriber according to an embodiment of the present invention and also to FIGS. 3 to 8 which show breakdowns of each of the stages in FIG. 2. In this example, the “user” is someone who is attempting to generate an itinerary and find a suitable companion or travelling companions to share the itinerary and a “subscriber” is a user who has created and saved an itinerary which has been made available as an invitation to others.

To access the full functionality of the itinerary builder, including saving an itinerary, users need to “log in” at step 104. To open an account at step 105, a user enters at step 106, personal information in a record including a name and an email address field which must be filled and the details of which are transmitted to the server 11 and stored in the database. An account has a unique identifier and is password protected and allows a subscriber to save itineraries. To ensure the user has entered an operating email address the unique identifier and password are sent to the user's email address. The user “logs in” by entering the unique identifier and password to open a session. The personal information record further includes optional age, gender, language and lifestyle fields. Additional personal information concerning the individual may be contained in the record which would include a field for a written statement by the individual and a picture field.

Opening the account at step 105 may include an optional step of completing a personality test 107. From the test each subscriber may be assigned a personality type, deemed to be socially or otherwise compatible with other individuals of the same type. In the preferred embodiment three personality types are assigned to subscribers, given the names Visual, Auditor and Kinesthetic. Also included is a wish list input at step 108 completed by the user to indicate a preference for suitable companions and defining the required age, gender, language and lifestyle.

As indicated at block 100, the user makes a selection of activities. At step 101 the user selection may be accessed from storage element 14 in response to a user request. The user request may be entered using many different methods and/or formats. In one embodiment, the request may be entered using one or more drop down lists. If two or more drop down lists are used then each successive list presented to the user will typically be more specific than the preceding list. For example, the user may be serially presented with a first list from which the user may select a region, a second list from which the user may select a country within the selected region, a third list from which the user may select a city within the country, a fourth list from which the user may select “food”, a fifth list from which the user may select “luxury”.

Accessing the starting set of activities typically comprises searching the activities stored in the database to retrieve activities that matches the user's request. The activities that have been accessed from the server 11 may then be transmitted to a client computer 15 such that the information can be displayed on a display 17 at step 102. As discussed above, the activities also comprise predefined itineraries. A list of predefined itineraries may be displayed, so as to enable the user to view all of the individual activities within each predefined itinerary. The activities and predefined itineraries may be displayed in many different formats. Regardless of the display format, however, the displayed information will typically be selectable by the user to enable the user to place the activities and predefined itineraries into a user activity pool to create a user travel itinerary. Preferably the activities are “bookmarked” at step 103, as by a toggle switch associated with each activity and predefined itinerary, for entry into the user activity pool.

Continuing the example given above, the displayed starting set of activities may include a number of activities within the selected city (e.g. tourist attractions, excursions, restaurants, hotels) associated together as a pre-defined itinerary, and a number of restaurants in the selected city (associated with the food—luxury selection). All users are able to complete steps 101-103 without first completing step 104, but the ability to select from the displayed starting set of activities is restricted to users who have not logged in. Such users are only able to select one of the predefined itineraries, whereas users who have an open session may choose predefined itineraries and the complete range of other activities.

Once the selection of activities from the starting set has been completed, each activity and predefined itinerary from the user activity pool would then typically be selected by the user to be scheduled into at least one day of travel, according to block 200 to generate a draft itinerary. A user selection of the activity pool at step 201 indicates completion of activity selection from the starting list and is followed by displaying a list of activities of the user activity pool and displaying an itinerary template, simultaneously at steps 202a, 202b.

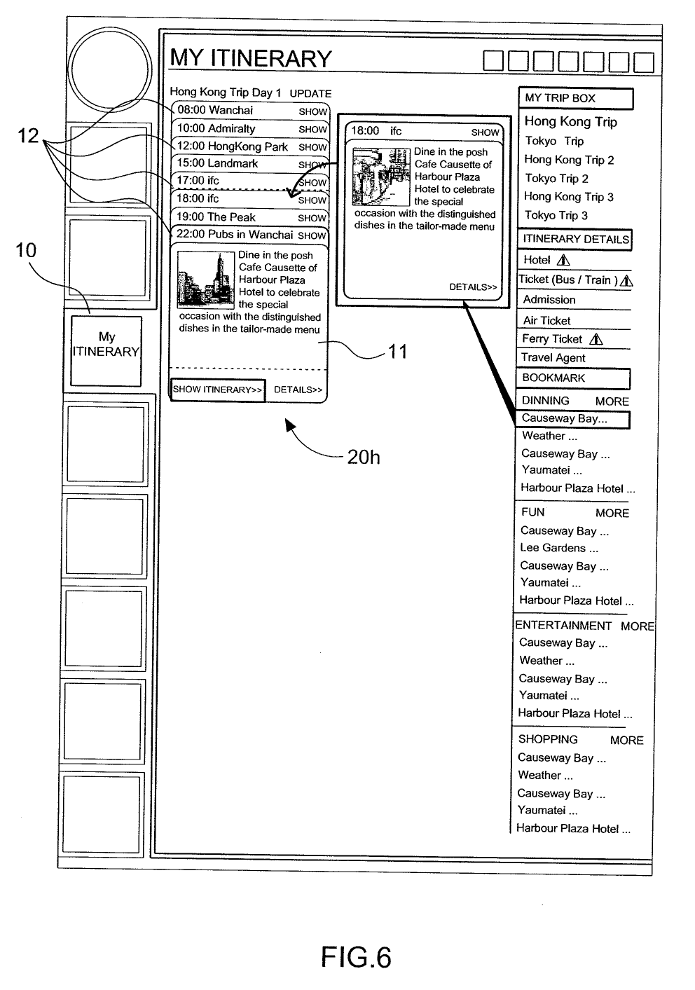

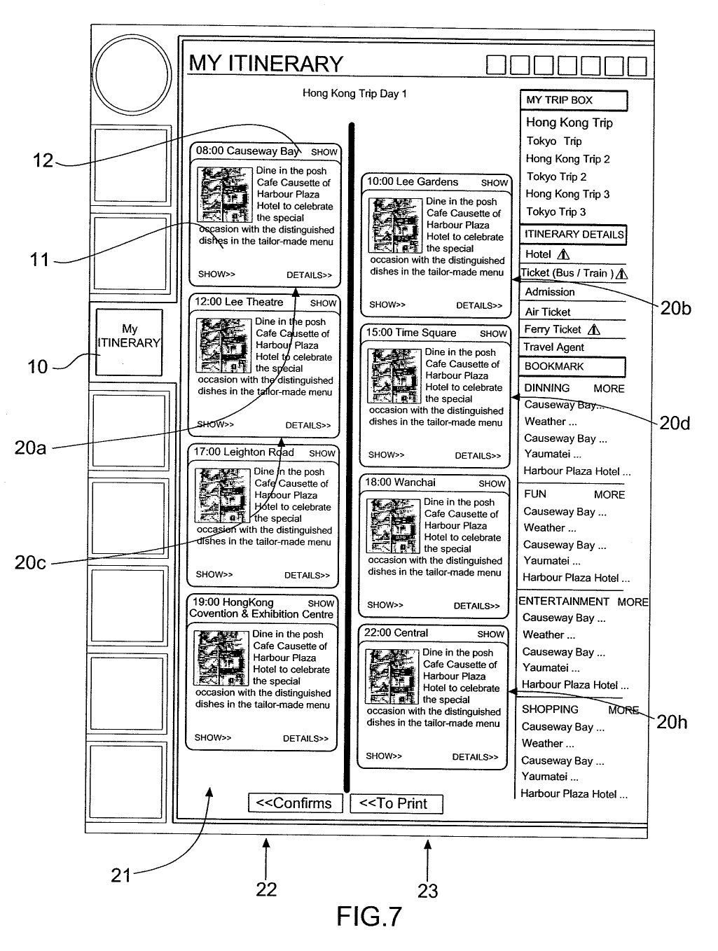

If the user activity pool comprises a predefined itinerary then the predefined itinerary is displayed in either expanded or compressed view (see FIG. 7 and FIG. 6 respectively) conditionally upon the state of a display toggle control 10. In the expanded view eight graphical user interface boxes 20a-20h of like size are spaced apart in a rectangular matrix 21 (FIG. 7), each of the graphical user interface boxes holding activity data 11, with indicia 12 along a common upper edge of each graphical user interface box defining a time associated with a timeslot in the itinerary and a title associated with each activity. The rectangular matrix 21 has two adjacent columns 22, 23, such that graphical user interface boxes for consecutive activities (e.g. boxes 20a/20b, 20b/20c, 20c/20d etc) are in transversely opposing ones of the columns 22, 23 and are staggered vertically to provide a good visual differentiation between the timeslots in the itinerary.

The compressed view (FIG. 6) resembles a stack of the graphical user interface boxes 20a-20h with the indicia 12 positioned adjacent one another in sequential order according to the displayed time such that only activity data 11 in a front graphical user interface box is visible.

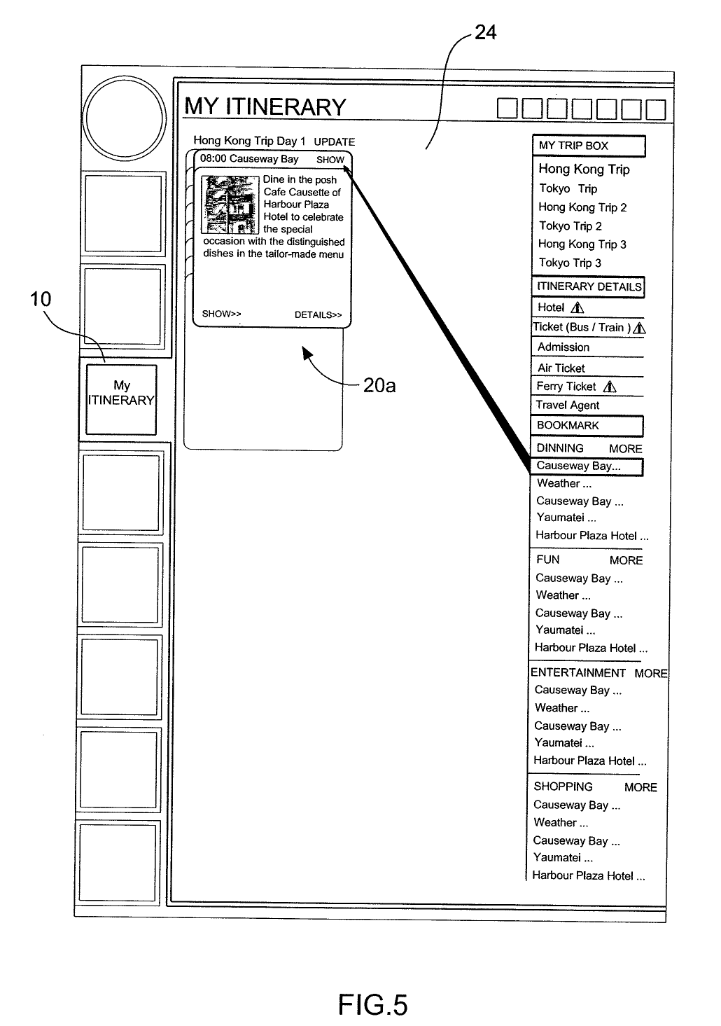

Alternatively if the user activity pool comprises activities not associated as predefined itinerary then the user may drag and drop each activity into the itinerary template 24. As shown in FIG. 5, when the first activity is placed in the blank itinerary template it is displayed as a single graphical user interface boxes 20a having a user-specified date and a specified timeslot within that day. The user's selection (i.e., activities and associated day/time) is typically transmitted from the client computer to the server, such that the processing element 12 may create a user travel itinerary in response to the user's selections. An itinerary for a trip may comprise a plurality of daily itineraries each comprising up to eight activities in the embodiment shown. The created user itinerary comprises the selected activities with an indication of which activity is desired on which day of travel.

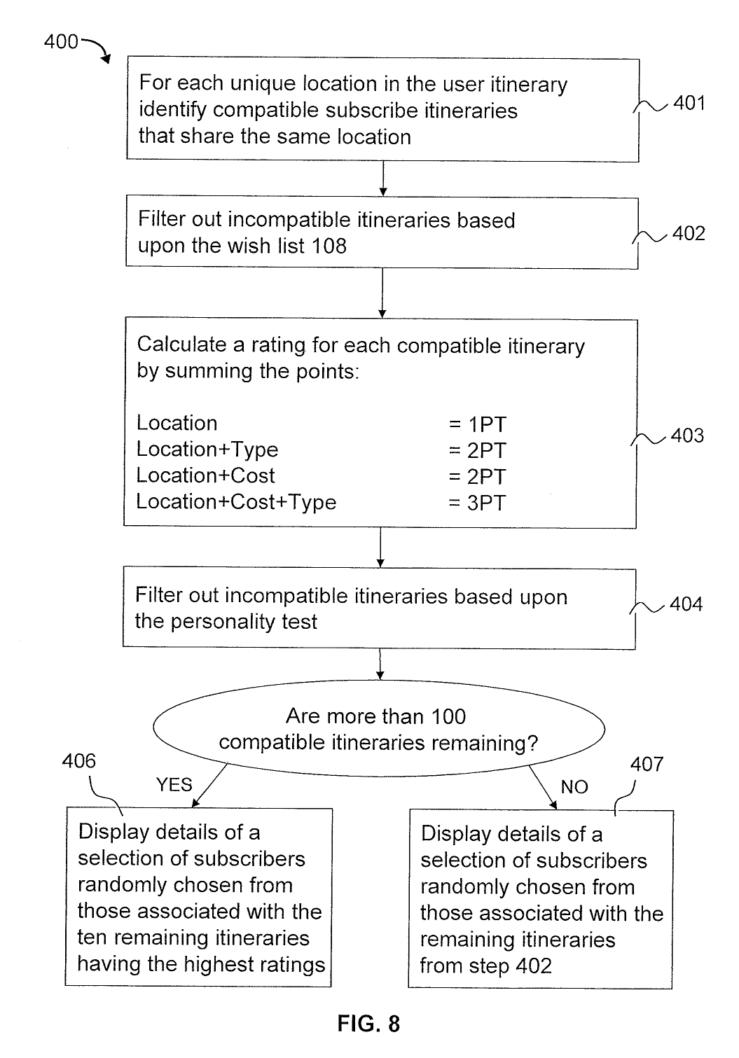

Following each entry into the itinerary a conflict check is performed. Likewise compatible itineraries are identified and displayed (as discussed below with reference to block 400 and FIG. 8) following each entry into the draft itinerary. The programme includes conflict checking rules to check the availability of subsequent activity entries based upon earlier activity entries, and to alert the user. The first predefined itinerary or activity placed in the draft schedule (shown in box 20a) defines a first location and first time window and a check for conflicts is made based upon the locations and time windows associated with each activity added later. Activities found to conflict are highlighted by showing the indicia 12 in a colour contrasting with those of the other activities. This alerts the user to potential errors, such as the mistaken drag and drop of a summer activity into a winter itinerary, the insertion of an activity in a second city into an itinerary in a first city, or the proposed timing of an activity so as to be incompatible with a schedule associated with the activity.

As shown at block 300, once the required activities have been entered the user is able to edit the itinerary. The user will typically select one or more travel activities and indicate the desired alternative day and/or time of travel for the selected activity(s) by a drag and drop to the alternative time, thus causing the processing element 12 to move the selected activity(s). A selected activity may be moved from one day of travel to a different day or from one time to a different time on the same day of travel. Again a conflict check is performed, and the compatible itineraries are identified (as described below) and displayed following each revision of the itinerary.

Also associated with each itinerary is a user-selectable flag indicating itineraries that should be made accessible to other users, thereby providing an invitation to others to accompany the user on the itinerary. When flagging a draft itinerary in this manner the user may also select a trip timeframe to provide potential companions with an indication of the user's flexibility with regard to the proposed scheduling of the trip. Once the draft itinerary has been completed and flagged for accessibility as desired, the itinerary is saved to the server as a proposed subscriber itinerary.

During the process of building or editing an itinerary, as part of determining compatible itineraries according to block 400, a compatibility rating is calculated following each entry into the itinerary only for users who have logged on. Firstly itineraries compatible with the draft user itinerary are identified from among the subscriber itineraries. Compatible subscriber itineraries include at least one activity having an activity location in common with an activity location of an activity in the user itinerary.

In the preferred embodiment, activities are classified by activity LOCATION, TYPE and COST. Firstly at step 401 the unique locations in the user itinerary are identified, and for each unique location a search is performed to identify compatible subscriber itineraries that share an activity having the same location.

Compatible itineraries not belonging to subscribers meeting the requirements of the user's wish list 108 are removed at step 402.

At step 403, for each remaining compatible itinerary an associated rating is calculated by summing points awarded in accordance with the LOCATION, TYPE and COST. The points are determined as follows, to increase the likelihood of compatibility between the user's proposed trips:

One point where a location in the compatible itinerary matches the unique location of the user itinerary.

Two points where both location and type of an activity in the compatible itinerary matches the location and type of an activity the user itinerary.

Two points where both location and cost of an activity in the compatible itinerary matches the location and cost of an activity the user itinerary.

Three points where the location, type and cost of an activity in the compatible itinerary matches the location, type and cost of an activity the user itinerary.

Compatible itineraries not belonging to subscribers having the same personality type 107 as the user are removed at step 404, to leave remaining compatible itineraries.

As seen from steps 405, 406 and 407, if there are over 100 remaining compatible itineraries, the personal details of the subscribers associated with a random selection of three from among the ten remaining compatible itineraries having the highest ratings is displayed. Otherwise, a random selection of three from among the displayed itineraries remaining from step 402 is made and the personal details of the subscribers associated with these three itineraries are displayed. These steps introduce an element of randomness to avoid the same small number of subscribers always being displayed each time the steps of block 400 are performed.

By then selecting from among the three displayed subscribers, the respective subscriber's itinerary is displayed. This allows the user to learn about both the subscriber and their proposed itinerary, before making a decision.

Once a decision has been made to contact a first chosen subscriber the user, at step 501, selects the first subscriber.

Then, upon selection of the desired itinerary, whether it is the user's own itinerary or the first subscriber's itinerary an email regarding the selected itinerary is sent to the first subscriber's email address. The selection may alternatively be for one or more activities in the itinerary, which for the purposes of the description herein is also considered an itinerary.

If the selected itinerary at step 502a is the user itinerary the email sent in the subsequent step 503a to the first subscriber contains a request that the first subscriber accompany the user on the user itinerary. The email contains a hyperlink to a web page in the storage 13 containing the user itinerary.

Otherwise if the selected itinerary at step 502b is the first subscriber itinerary the email sent in the subsequent step 503b to the first subscriber contains a request that the first subscriber accompany the user on the first subscriber itinerary. Correspondingly in this case the email contains a hyperlink to an acceptance web page in the storage 13 containing the subscriber itinerary. Upon sending the emails at steps 503a, 503b a timer records a start time.

To generate a shared itinerary the subscriber must open the hyperlink to the acceptance web page. The system displays on the acceptance web page an “accept” button at step 504 and when the subscriber actuates this button a shared itinerary is generated at step 505, accessible to both the user and subscriber through their respective online accounts. The shared itinerary comprised the user itinerary if steps 502a and 502b were followed, or the first subscriber itinerary if steps 502b and 503b were followed. A shared itinerary is differentiated from other itineraries on the display 17 by use of contrasting colours.

Alternatively, rather than accepting the proposed itinerary the first subscriber may propose a variation to the itinerary and return email a hyperlink to an acceptance web page for the user.

Should an elapsed time measured from the starting time exceed 24 hours then an email is sent to the user advising of this and containing a link to his saved itinerary to allow him to invite other subscribers according to steps 502a, 502b.

Aspects of the present invention have been described by way of example only and it should be appreciated that modifications and additions may be made thereto without departing from the scope thereof.

1. A method implemented by a computer for generating an itinerary to be shared by a user and a first subscriber of a group of subscribers, the method comprising:
(a) generating a plurality of subscriber itineraries, each subscriber itinerary being associated with a subscriber, each subscriber itinerary including one or more activities selected from a user activity pool, each activity including activity data, the activity data including an activity location associated with performing the activity;
(b) generating a user itinerary for a user, the user itinerary including one or more activities selected from the user activity pool;
(c) identifying compatible itineraries from among the subscriber itineraries, compatible subscriber itineraries including at least one activity having an activity location in common with an activity location of an activity in the user itinerary,
(d) displaying a selection from the compatible itineraries;
(e) receiving a selection from among the displayed itineraries of a first subscriber itinerary associated with the first subscriber;
(f) receiving a user selection indicating a desire to contact the first subscriber with a request that the first subscriber accompany the user on either the user itinerary or on the first subscriber itinerary, and
(g) initiating contact with the first subscriber in response to the user selection.

2. The method of claim 1 wherein, if more than one compatible subscriber itinerary is identified at step c), the method further includes calculating a rating for each compatible subscriber itinerary which increases with the number of activities having activity locations shared with the user itinerary, and at step d) displaying a selection from the compatible itineraries with highest ratings.

3. The method of claim 2 wherein step g) includes transmitting an email specifying the request that the first subscriber accompany the user on either the user itinerary or on the first subscriber itinerary according to the user selection.

4. The method of claim 3 wherein
the activities are classified according to at least one classification included in the activity data and
the rating calculated at step c) is further increased according to number of activities having both activity locations and classifications shared with the user itinerary.

5. The method of claim 2 wherein calculating the rating further includes incorporating in the rating a scoring based upon analysis of answers to a questionnaire completed by the user and the subscribers.

6. The method of claim 1 wherein generating a user or subscriber itinerary at step a) or step b) comprises:
(a) receiving a user selection of the user activity pool;
(b) displaying a list of activities of the user activity pool;
(c) displaying an itinerary template, and
(d) receiving into timeslots in the itinerary template selected ones of the user activity pool displayed to complete the itinerary.

7. The method of claim 4 wherein receiving the user selection of the user activity pool comprises either:
(a) receiving a user selection of a pre-defined itinerary or a pre-defined itinerary part defining the user activity pool, or
(b) receiving a user selection of individual activities from a starting set of activities to define the activities of the user activity pool.

8. The method of claim 1 wherein the generation of each subscriber itinerary at step a) further includes:
(a) receiving input into fields in a subscriber registration file, the fields including a subscriber name field, a subscriber email address field, and
(b) saving each subscriber registration file with an associated subscriber itinerary.

9. The method of claim 1 wherein selected ones of the activities are placed into timeslots by a drag-and-drop selection from the user activity pool displayed.

10. The method of claim 1 wherein the activities include date-specific activities which can be performed within a date window, the method further including:
(a) receiving a selection, separate from the selection of an activity, of a proposed date range during which the itinerary is proposed to be completed, and
(b) identifying a date window in the activity data for each date-specific activity and checking for conflict between the date window and the proposed date range and highlighting any activities found to conflict.

11. The method of claim 1 wherein the activities include purchasable and non-purchasable activities, the method further including sending the itinerary to an electronic reservation system such that the electronic reservation system creates a reservation record, the reservation record comprising a reservation for each purchasable activity.

12. The method of claim 1 wherein displaying the itinerary includes displaying either expanded or compressed views of a itinerary conditionally, depending upon the state of a display toggle control, the expanded view including a plurality of graphical user interface boxes of like size and spaced apart in a rectangular matrix, each of the graphical user interface boxes holding activity data, with indicia along a common edge of each graphical user interface box defining a time associated with a timeslot in the itinerary and a title associated with each activity, and the compressed view resembling a stack of the graphical user interface boxes with the indicia positioned adjacent one another, in sequential order, according to the time displayed such that only activity data in a front graphical user interface box is visible.

13. The method of claim 12 wherein the common edge is an upper edge of each graphical user interface box and the rectangular matrix comprises two adjacent columns, such that graphical user interface boxes for consecutive activities are in transversely opposing columns and are staggered vertically.

14. The method of claim 13 wherein displaying the itinerary includes displaying proposed date range in both the compressed and expanded views.

15. The method of claim 6 wherein further comprising moving a selected activity from one day timeslot to a different timeslot in response to a drag-and-drop selection and placement by the user.

16. A display arrangement system for displaying an itinerary in which each timeslot in the itinerary is represented as a graphical user interface box on a graphical user interface, the display arrangement system comprising:
(a) a display for displaying the set of graphical user interface boxes in the graphical user interface;
(b) a memory for storing a plurality of instructions that are associated with a plurality of functions; and
(c) a processor for executing the plurality of instructions stored in the memory upon a change of state of a display toggle control, the execution of the plurality of instructions causing at least one of the plurality of functions to be performed, including:
(i) generating an expanded view of a plurality of the graphical user interface boxes, the graphical user interface boxes having a like size and being spaced apart in a rectangular matrix, each of the graphical user interface boxes holding activity data and defining a timeslot in the itinerary, with indicia along a common edge of each graphical user interface box defining a time associated with the timeslot and a title associated with each activity, and
(ii) generating a compressed view of a plurality of the graphical user interface boxes, the compressed view resembling a stack of the graphical user interface boxes with the indicia positioned adjacent one another in sequential order according to the displayed time such that only activity data in a front graphical user interface box is visible.

17. A computer-readable medium having executable instructions for generating an itinerary to be shared by a user and a first subscriber from a group of subscribers, the instructions comprising:
(a) generating a plurality of subscriber itineraries, each subscriber itinerary being associated with a subscriber, each subscriber itinerary including one or more activities selected from a user activity pool, each activity including activity data, the activity data including an activity location associated with performing the activity;
(b) generating a user itinerary for a user, the user itinerary including one or more activities selected from the user activity pool;
(c) identifying compatible itineraries from among the subscriber itineraries, compatible subscriber itineraries including at least one activity having an activity location in common with an activity location of an activity in the user itinerary, and if more than one compatible subscriber itinerary is identified, calculating a rating for each compatible subscriber itinerary which increases with the number of activities having activity locations shared with the user itinerary;
(d) displaying a selection from the compatible itineraries with the highest ratings;
(e) receiving a user selection from among the displayed itineraries of a first subscriber itinerary associated with the first subscriber
(f) receiving a user selection indicating a desire to contact the first subscriber with a request that the first subscriber accompany the user on either the user itinerary or on the first subscriber itinerary, and
(g) transmitting to the first subscriber, in response to the user selection, an email specifying the request that the first subscriber accompany the user on either the user itinerary or on the first subscriber itinerary according to the user selection.
